(19) United States
(12) Patent Application Publication
(10) Pub. No.: US 2015/0250336 A1
(43) Pub. Date: Sep. 10, 2015

(54) MIXED MEDIA COLLAGE AND METHOD OF MAKING

(71) Applicant: Ronald Weintraub, New York, NY (US)

(72) Inventor: Ronald Weintraub, New York, NY (US)

(21) Appl. No.: 14/581,513

(22) Filed: Dec. 23, 2014

(51) Int. Cl. A47G 1/16; G09F 15/00

(52) U.S. Cl. CPC A47G 1/16; G09F 15/0006

(57) ABSTRACT

The present invention relates to a mixed media collage which may comprise action figures securely attached, yet detachable, to a canvas through the use of an eye screw, a screw or a wire fastener. The mixed media collage may comprise a canvas having a front surface and a back surface, stretched on a frame and having a screw hole from the front surface to the back surface, a plurality of action figures disposed on the front surface and having a screw hole therein, and, most preferably, an eye screw screwed through the back surface of the canvas through the screw hole of the canvas and into the screw hole of the action figure.

### FIELD OF THE INVENTION

The present invention relates to a mixed media collage which may comprise action figures affixed to a canvas. More particularly, it relates to a mixed media collage and method for making the same and may comprise the detachable attachment of action figures to a canvas or other substrate through the use of an eye screw, a screw or a wire fastener.

### RELATED ART

This invention relates to a mixed media collage and more particularly to a mixed media collage which may comprise action figures securely attached, yet detachable, to a canvas through the use of a fastener. The fastener may be an eye screw, a screw or a wire fastener.

Early collages created by the artists George Braque, Pablo Picasso, Kurt Schwitters and others, utilized flat objects such as newspaper clippings, ticket stubs, photographs and other ephemera which were affixed to the canvas with glue. Later, attempts were made to affix non-flat objects with glue but often the three-dimensional objects would fall off; the most notable example being Julian Schnabel's painted plates. In the last decade, stronger, industrial strength glues have been produced, but even these fail to secure non-flat objects.

Various methods for fastening three-dimensional objects to flat canvas-like substrates without the use of glue have been attempted.

U.S. Pat. App. Pub. 2008/0110072 by C. Lacoff, discloses a display device for attachment of a three-dimensional objects, such as jewelry, to a two-dimensional surface. Lacoff discloses that the jewelry structure itself is used for attachment through the two-dimensional surface.

U.S. Pat. No. 4,687,103 to M. Corbett, entitled “Jewelry display device,” discloses a display article similar to Lacoff's wherein the structure of the display articles themselves penetrate a panel.

German Pat. No. DE3506802 to G. Heinicke, entitled “Surface decoration,” discloses attachment of surface decorations, such as faux foliage, to a substrate using through-hole resilient members which are part of the structure of the decorations. It appears that removal of an item is likely to damage the item or substrate.

U.S. Pat. No. 2,458,493 to E. Troy, discloses artwork comprising a painted fabric base upon which stones or other rigid, decorative elements, such as gems, can be mounted by means of anchoring clamps. Such clamps are disclosed to have prongs which penetrate the painted fabric base for securing the decorative elements.

None of the above disclosures, taken either singly or in combination, is seen to describe the instant invention as claimed. There exists a need in the collage arts to go beyond attaching old-style flat objects to a canvas or a canvas-like material to incorporate non-flat, irregular or three-dimensional elements securely without or with limited use of glue.

It is an object of the invention to provide a convenient, yet effective, means for fastening irregular or three-dimensional elements to flat or two-dimensional conventional works of art, such as paintings, in a mixed media collage. Such means should be adaptable

It is another object of the invention to provide fastening means that allow for flexibility in the creative process by facilitating detachment and reattachment of irregular or three-dimensional collage elements in a variety of canvas locations based on the artist's judgment during collage creation.

Thus, a mixed media collage solving the aforementioned problems is desired.

### BRIEF SUMMARY OF INVENTION

Accordingly, the limitations and problems as just described are obviated according to embodiments of the present invention which include a mixed media collage with fastening means to attach a three-dimensional object to a two-dimensional canvas artwork. In one embodiment, the three-dimensional object may be an action figure or figurine. In some embodiments, the two-dimensional canvas artwork is a painting and/or an assemblage of two-dimensional materials. In yet another embodiment, an eye screw, screw or wire is used as a fastener. Each of these fasteners can securely, yet detachably, affix a non-flat object to a canvas. These fastening means open up a wide range of creative options and is highly desirable from an artistic and commercial perspective.

According to one embodiment, there is a mixed media collage having a base work, the base work having a canvas with a front surface and a back surface and the canvas is stretched on a frame. The front surface has a substantially flat art production and a plurality of screw holes from the front surface to the back surface. There are three-dimensional figures on the front surface, each three-dimensional figure having at least one point of contact with the front surface at which there is a non-through screw bore into the three-dimensional figure. The screw bore is substantially perpendicular to the canvas and located over a corresponding screw hole in the canvas. A screw is screwed into each screw bore, through the canvas. The screw heads are flush or snug to the back surface of the canvas.

In some embodiments, the screws are eye screws. In some embodiments, the base work comprises a painting, a photograph, printed materials, or any combination thereof In some embodiments, the canvas is fabric, wood or fiberboard. In some embodiments, the three-dimensional figures are action figures, figurines, animal figures, and/or irregularly shaped objects. In some embodiments, the screw bores of said action figures are into a back torso and/or located at or above a center of gravity. In some embodiments, the screws may be eye screws, slotted screws, Phillips screws, Robertson screws or Torx screws. In some embodiments, one or more of the three-dimensional figures are further secured to the canvas with glue. In some embodiments, the three-dimensional figures are further secured to the canvas with a thin wire wrapped around a portion of the figure and inserted through two holes in the canvas immediately behind; the ends of the wire are twisted together snug to the back of the canvas.

In some embodiments, there is a mixed media collage having a canvas stretched on a frame with a front surface and a back surface; the front surface has a two-dimensional art production and the canvas has screw holes from the front surface to the back surface. A plurality of action figures are attached to the front surface by means of screws engaged from the back surface of the canvas and into bores in the action figures.

There is also provided a method of making a mixed media collage of a canvas with an action figure attached to the front, the method having steps of creating a bore in the action figure, creating a corresponding screw hole in the canvas, aligning the action figure bore in front of the canvas screw hole, and screwing a screw through the back side of the canvas into the bore in the action figure until the head of the screw is snug against the back side of the canvas and the back of the action figure is snug against the front side of the canvas.

The method may be carried out using an eye screw, drilling, and punching. The method may further include a step of creating a substantially flat art production on the front side before creating the screw hole. The method may be carried out by creating the bore at or above the center of gravity of the action figures.

The foregoing features, benefits and advantages, together with additional features, benefits and advantages, will become apparent from the ensuing detailed description of a preferred embodiment and the accompanying drawings. The best mode contemplated in practicing the invention is disclosed and the subject matter in which exclusive property rights are claimed is set forth in each of the numbered claims at the conclusion of the detailed description.

### BRIEF DESCRIPTION OF DRAWINGS

For a comprehensive exposure of the features, nature and advantageous effects of the present invention, reference is now made to the detailed description in conjunction with the associated drawings, in which:

FIG. 1 is a side-front perspective view of a mixed media collage according to an exemplary embodiment of the present invention.

FIG. 2 is a cross sectional side-front perspective view taken along line x-x of the mixed media collage of FIG. 1 according to an exemplary embodiment of the present invention.

FIG. 3 is an exploded cross sectional side-rear perspective view of a detail taken along line x-x of the mixed media collage of FIG. 1 according to an exemplary embodiment of the present invention.

FIG. 4 is a side-front perspective view of a mixed media collage depicting a mixed media collage according to an exemplary embodiment of the present invention.

FIG. 5 is a side-rear perspective view of a mixed media collage depicting a mixed media collage according to an exemplary embodiment of the present invention.

FIG. 6 illustrates an exemplary method in accordance with the invention.

### DETAILED DESCRIPTION OF THE INVENTION

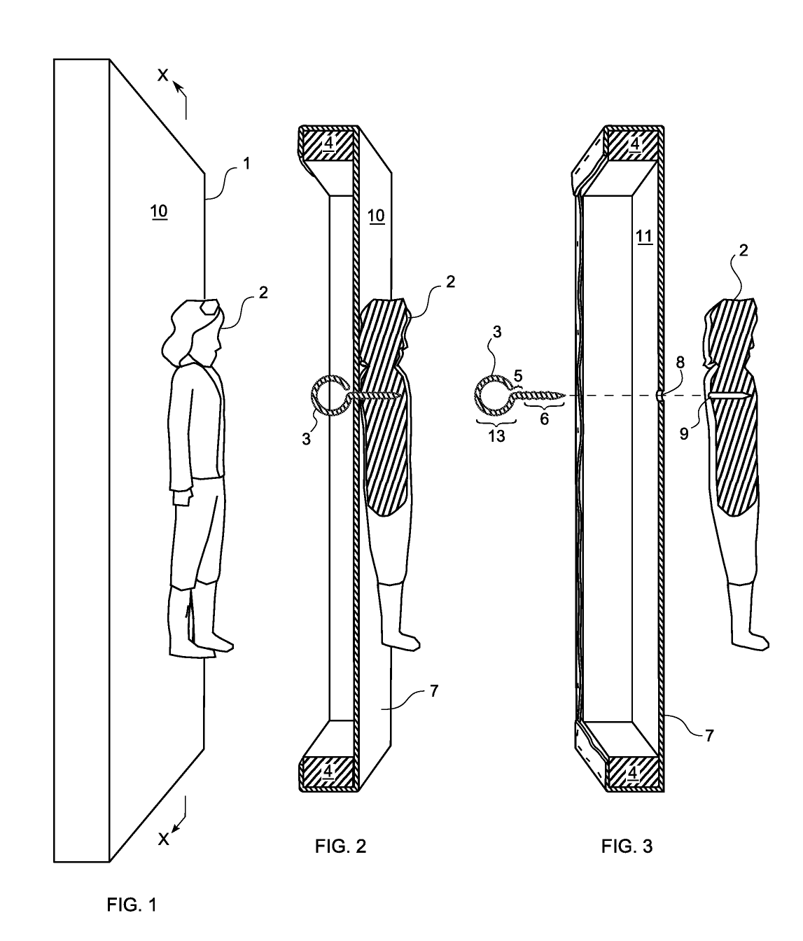

With reference now to FIGS. 1-3 of the drawings, a two-dimensional base work 1 is shown having a front surface 10 and a back surface 11. The material upon which the base work 1 is made is preferably comprised of a canvas 7 fabric stretched on a frame 4. The base work 1 may comprise a substantially flat art production, such as artwork made from paint (not shown) brushed onto canvas 7 material according to artistic preference. In alternative embodiments, canvas 7 may be, but is not limited to, wood, fiberboard or other types of fabrics and lightweight art substrates. The base work 1 may comprise other substantially flat materials, including an assemblage of materials (not shown) such as photographs, papers, and other colored, patterned or printed materials arranged according to artistic preference. Disposed on the front surface 10 of the base work 1 is a three-dimensional action FIG. 2, which may comprise a molded material, preferably plastic. In alternative embodiments, the three-dimensional figure attached to the front surface 10 of the base work 1 may be a figurine or any non-flat, irregularly shaped object. In a preferred embodiment, the rear of the action FIG. 2 may be attached to the front surface 10 of the base work 1 as discussed below.

FIG. 2 is a cross sectional view of a detail taken along line x-x cutting through the action FIG. 2. Eye screw 3 comprises a screw head 13 and a shank which has a threaded shaft 5 portion and a threaded end 6 portion. The cross sectional view shows that the eye screw 3 threaded shaft 5 is engaged axially with the canvas 7 through a canvas 7 screw hole 8 and that head 13 is snug against canvas 7 rear surface 11. The eye screw 3 threaded end 6 is substantially engaged axially with the action FIG. 2 screw hole 9 and substantially embedded within the action FIG. 2, preferably within a bore in the torso, according to an exemplary embodiment of the present invention. Use of an eye screw 3 is advantageous as the eye of the screw is amenable to handling between the artist's index finger and thumb of one hand, thereby allowing the artist to drive and turn the screw without the use of a screwdriver while keeping the FIG. 2 aligned on the other side of canvas 7 with the other hand.

FIG. 3 is an exploded cross sectional view and also serves to illustrate the components pre-assembly or post-assembly. FIG. 3 illustrates that the eye screw 3 threaded shaft 5 is disengaged axially from the canvas 7 and the canvas 7 screw hole 8. The eye screw 3 threaded end 6 is disengaged axially from the action FIG. 2 screw hole 9 and is no longer embedded within the action FIG. 2. The exposed eye screw 3 threaded shaft 5 and threaded end 6 protrude axially for engaging the canvas 7 screw hole 8 and the action FIG. 2 screw hole 9 for embedding within the action FIG. 2.

The use of eye screws 3, as opposed to conventional glue, increases the creative options for the artist. With screw type fasteners, the artist can easily detach a fastened three-dimensional object by unscrewing the fastener and simply reattaching the object by re-screwing it in a different front surface 10 location of canvas 7 based on aesthetic judgments made during the creative process. On the other hand, use of permanent glue fastening means makes detachment of three dimensional objects difficult and may deface the figure and the painting on their respective contact points. Although the use of screw type fasteners is advantageous over the use of glue fasteners alone, supplemental use of glue fasteners for added stability is within the scope of the present invention. Such use is particularly useful when fastening three-dimensional objects that are large, irregularly shaped and/or heavy.

The present invention also includes other types of screws instead of eye screw 3 including conventional screws that require a screwdriver. Conventional screws within the scope of the invention include screws with drives in the form of a regular slot, Phillips, Robertson, Torx, and Double-Square.

Alternative embodiments for fastening three-dimensional figures include use of a thin wire (not shown) in place of or in addition to a screw type fastener. This is an embodiment usable in instances where the material or structure of the action FIG. 2 is not suitable for a screw, e.g., too hard, too small, too soft, too thin. When thin wire fasteners are used, the artist may wrap the wire around the action FIG. 2 and then insert the two ends of the wire through the canvas 7, through holes behind the figure. Fastening is complete when the two wire ends are pulled to take up slack around the action FIG. 2 and the two wire ends are bent in opposite directions or tied together to prevent substantial slackening.

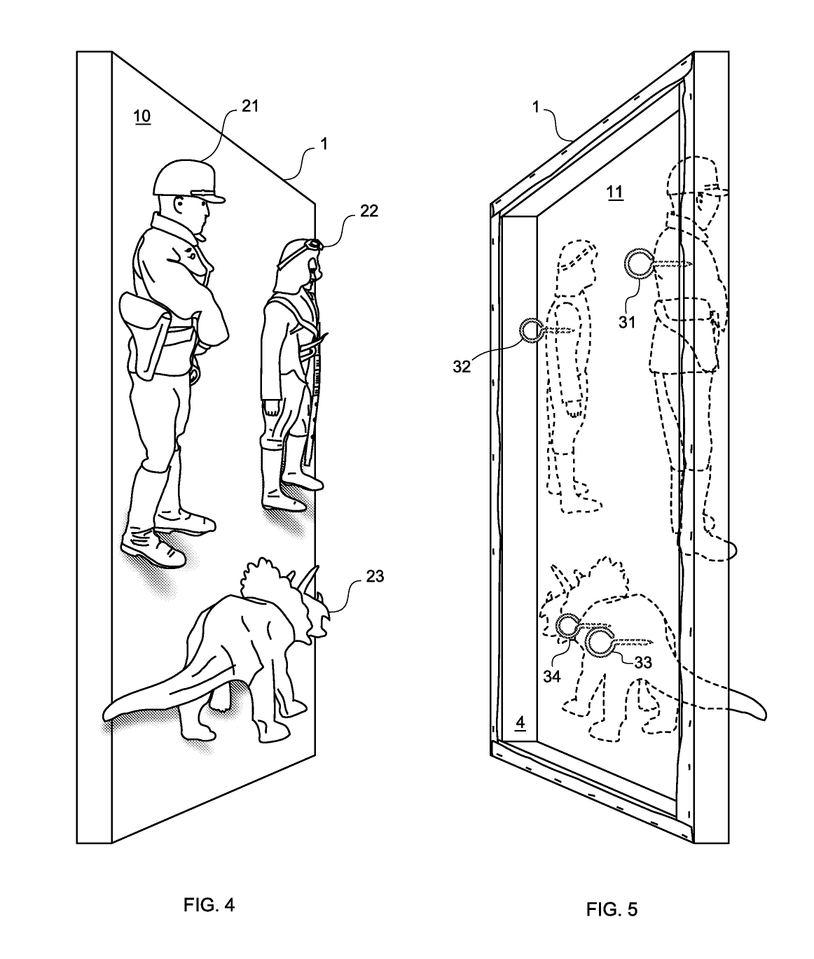

With reference to FIG. 4, in some embodiments of the invention, there may be a plurality of action figures attached to a front surface 10 of a base work 1 and they may be arranged in a variety of locations on the base work 1 front surface 10 according to artistic preference. FIG. 4 illustrates a perspective view of a mixed media collage having three-dimensional FIGS. 21, 22, 23 shown on the front surface 10 of the base work 1.

FIG. 5 is a side-rear perspective view of the mixed media collage shown in FIG. 4, depicting the rear of a two-dimensional base work 1 with a plurality of eye screws 31, 32, 33, 34 extending outward from the rear surface 11 of the two-dimensional base work 1. The plurality of three-dimensional FIGS. 21, 22, 23 on the surface of the front of the base work 1 are shown in phantom line. Each eye screw 3 threaded end 6 is axially in line and substantially engaged with action FIG. 2 screw holes 9 within each action FIG. 21, 22, 23, according to an exemplary embodiment of the present invention.

The present invention may comprise a plurality of attachments per action figure such as that illustrated in FIG. 5 for action FIG. 23. As illustrated, a plurality of eye screws, i.e., eye screws 33, 34, may be engaged individually axially with the canvas 7 and eye screws 33, 34 threaded ends may be axially engaged with single action FIG. 23 screw holes. Use of a plurality of eye screws 3 per action FIG. 2, figurine or any non-flat, irregularly shaped object is particularly useful when fastening a three-dimensional object that is large, irregularly shaped, heavy, or having a center of gravity that is not at or below a single attachment point.

The canvas 7 screw hole 8 may be formed by pre-drilling using a conventional drill and drill bit or may be formed by piercing the canvas 7 with a sharp object, such as a nail, a punch, or a screw type fastener. In a preferred embodiment, the action FIG. 2 screw hole 9 is pre-drilled in the rear (the side that will be in contact with canvas 7) of the action FIG. 2 prior to fastening using a drill bit slightly narrower in diameter than the diameter of the eye screw 3 threaded shaft 5. The action FIG. 2 screw hole 9 may be pre-threaded by driving and turning the eye screw 3 threaded end 6 into the rear of the action FIG. 2 until the eye screw 3 threaded shaft 5 is embedded into the action FIG. 2 torso.

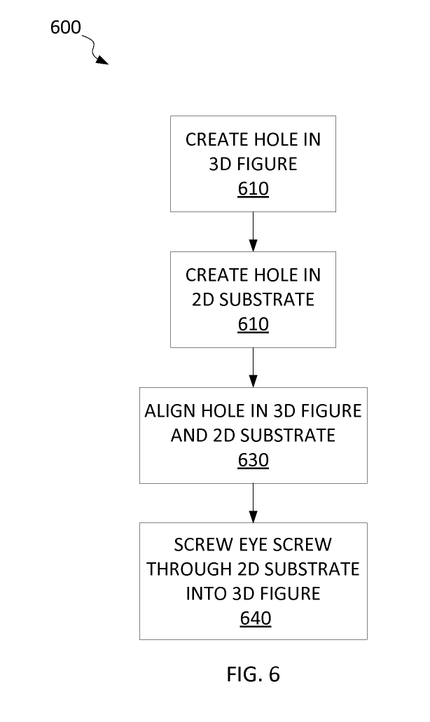

FIG. 6 illustrates a process in accordance with the invention. In process 600, there is a step 610 wherein a hole is created in the action figure, e.g., hole 9 action FIG. 2, to be attached to the two-dimensional surface, e.g., canvas 7. There is also a step of creating a matching hole in the two-dimensional surface, e.g., hole 8 in canvas 7. After the holes have been prepared, there is a step 630 of aligning the action figure in front of the two-dimensional surface so that that their holes align. Then there is a step 640 in which the eye screw, e.g., eye screw 3, is screwed from behind and through the two-dimensional surface into the action figure.

It should be emphasized that the above-described exemplary embodiments of the present disclosure are merely possible examples of implementations set forth for a clear understanding of the principles of the disclosure. Many variations and modifications may be made to the above-described exemplary embodiment(s) without departing substantially from the spirit and principles of the disclosure. All such modifications and variations are intended to be included herein within the scope of this disclosure and protected by the following claims.

I claim:

1. A mixed media collage, said mixed media collage comprising:
a base work, the base work having a canvas with a front surface and a back surface, the canvas stretched on a frame, the front surface comprising a substantially flat art production, the canvas having a plurality of screw holes from the front surface to the back surface;
a plurality of three-dimensional figures disposed on the front surface, each said three-dimensional figure having at least one point of contact with the front surface at which there is a non-through screw bore into the three-dimensional figure, said screw bore substantially perpendicular to the canvas and disposed over a corresponding one of the plurality of screw holes in the canvas, and,
for each of said screw bores, a screw disposed and frictionally engaged therein, wherein a portion of a shank of said screw is disposed in the corresponding one of the plurality of screw holes in the canvas and a head of said screw is disposed snugly to the back surface of the canvas.

2. The mixed media collage of claim 1, wherein each screw is an eye screw.

3. The mixed media collage of claim 1, wherein the base work comprises a painting, a photograph, printed materials, or any combination thereof.

4. The mixed media collage of claim 1, wherein a material of said canvas is selected from the group consisting of fabric, wood or fiberboard.

5. The mixed media collage of claim 1, wherein said plurality of three-dimensional figures are selected from the group consisting of an action figure, figurine, an animal figure, and an irregularly shaped object.

6. The mixed media collage of claim 5, wherein said plurality of three-dimensional figures are action figures.

7. The mixed media collage of claim 6, wherein said screw bores of said action figures are into a back of a torso of said action figures.

8. The mixed media collage of claim 7, wherein said screw bores into the action figures are disposed at or above a center of gravity of said action figures.

9. The mixed media collage of claim 1, wherein each screw is one of an eye screw, slotted screw, Phillips screw, Robertson screw or a Torx screw.

10. The mixed media collage of claim 1, wherein at least one of the three-dimensional figures is further secured to said canvas with glue.

11. The mixed media collage of claim 1, wherein at least one of the three-dimensional figures is further secured to said canvas with a thin wire disposed around a portion of said figure and through two holes in the canvas immediately behind the portion, wherein ends of said wire are twisted together snug to the back of the canvas.

12. A mixed media collage comprising a canvas having a front surface and a back surface, said canvas stretched on a frame, said front surface having a two-dimensional art production thereon, said canvas having a plurality of screw holes from the front surface to the back surface, a plurality of action figures disposed on the front surface and having bores therein, and, for each of said screw hole, an eye screw screwed through the back surface of the canvas through the screw hole of said canvas and into a bore of one of said action figures.

13. A method of making a mixed media collage comprising a canvas having an action figure disposed on a front side thereof, the method comprising:
creating a bore in the action figure,
creating a corresponding screw hole in the canvas,
aligning the action figure bore in front of the canvas screw hole, and
screwing a screw through a back side of the canvas into the bore in the action figure until the head of the screw is snug against the back side of the canvas and a back of the action figure is snug against the front side of the canvas.

14. The method of making a mixed media collage of claim 13, wherein the screw is an eye screw.

15. The method of making a mixed media collage of claim 13, wherein the bore is created by drilling.

16. The method of making a mixed media collage of claim 13, wherein the screw hole is created by punching.

17. The method of making a mixed media collage of claim 13, further comprising a step of creating a substantially flat art production on the front side before creating the screw hole.

18. The method of making a mixed media collage of claim 13, wherein the bore is created at or above a center of gravity of said action figure.
